(19) United States
(12) Patent Application Publication
(10) Pub. No.: US 2009/0086027 A1
(43) Pub. Date: Apr. 2, 2009

(54) Method And System For Providing Images And Graphics

(76) Inventors: Benjamin Antonio Chaykin, Leawood, KS (US); Adam Eugene Kellogg, Kansas City, MO (US)

Correspondence Address: LATHROP & GAGE LC, 2345 GRAND AVENUE, SUITE 2800, KANSAS CITY, MO, 64108, US

(21) Appl. No.: 12/034,748

(22) Filed: Feb. 21, 2008

Related U.S. Application Data
(60) Provisional application No. 60/976,649, filed on Oct. 1, 2007.

(51) Int. Cl. H04N 5/225

(52) U.S. Cl. 348/169; 348/61; 705/14; 348/E05.024

(57) ABSTRACT

A system detects a subject(s) or recipient(s), or an object(s) associated therewith, and sends a communication, for example, a message, to the subject, or object associated therewith, collectively, the “subject.” The communication is projected as an image proximate to the subject, and is projected to the subject when stationary or in motion, and in some cases, the communication is selected based on the direction of travel of the subject.

### CROSS REFERENCES TO RELATED APPLICATIONS

This patent application is related to and claims priority from U.S. Provisional Patent Application Ser. No. 60/976,649, filed Oct. 1, 2007, entitled: Method And System For Providing Images and Graphics, the disclosure of which is incorporated by reference herein.

### TECHNICAL FIELD

The present disclosed subject matter is directed to providing communications to recipients, by providing a message, such as advertising messages, to a recipient, or an object associated with the recipient. Messages are provided continuously to the recipients, or objects associated therewith, whether the recipient or object is stationary or moving.

### BACKGROUND

Advertisers are always searching to identify and engage customers. If a potential customer can be identified and engaged in a captivating and interesting manner, the chances of influencing the potential customer are increased, especially if the message can be delivered at the moment of decision with regard to a sale. Moreover, the longer a customer remains captive, exposed and engaged with the message, the greater the chance the advertiser will be successful in the consumer purchasing the advertised good or service.

Images and graphics projected to consumers are common. However, these graphics are not individualized, but are usually broadcasted on a group of customers on a random or mass basis. Accordingly, this advertising also lacks great chances of success.

### SUMMARY

The present disclosed subject matter provides a system that detects a subject or recipient (subject and recipient used interchangeably herein), or an object associated therewith (the subject and object associated therewith collectively referred to as the subject), and sends a communication, for example, a message, to the subject, or object associated therewith, that is, for example, projected as an image proximate to the subject. The subject or recipient may include an individual or group of individuals, such as a group of individuals in proximity to each other. The system provides one or more messages to the subject (recipient), while the subject is stationary or moving. The message is projected to a location proximate to the subject, for example, a surface such as the floor. The message is visible to the subject, for example, in the subject's field of vision, including when the subject is moving. The message is projected from the time the subject (recipient) enters the work area and is detected by the detector, as programmed into the detector, until the subject (recipient) leaves the work area, or the system experiences a timeout or other controlled cancellation. The work area is, for example, based on the range of the detector and the projector.

The message projected may be a single message or multiple messages, changed at varying time intervals, or randomly. The message or messages may also be based upon the present location of the subject (recipient) in the work area. The messages may also be individualized for each subject (recipient).

The system operates at frequent intervals to rapidly detect the subject, and then track the subject (recipient). This allows for projection of a single or multiple messages, for example, individualized messages, to the subject, until the subject is out of the designated area or work area (or other controlled termination of the message being projected).

The disclosed subject matter is directed to a method for delivering at least one communication, for example, a message, to at least one recipient. The method includes, detecting the subject corresponding to the recipient and making a representation of the subject at a first time; determining a subject area on a surface corresponding to the representation of the subject; and, providing at least one communication at least proximate to the subject area on the surface. The subject and the recipient may be the same entity, for example, a human or other group of humans, or different entities, for example, an object or group of objects associated with a human or group of humans.

The disclosed subject matter is directed to a method for delivering at least one communication to at least one subject. The method includes continuously scanning a predetermined area at predetermined intervals to detect a subject once the subject has been detected; making a representation of the subject at each predetermined interval while the subject remains detected; determining a subject area on a surface corresponding to the representation of the subject; and, providing at least one communication at least proximate to the subject area on the surface. The subject may be, for example, one or more humans or other living beings or an object or group of objects.

The disclosed subject matter is also directed to a system for providing at least one communication to a subject. The system includes a detector for detecting a subject in a predetermined area and a projector for projecting at least one communication to a location at least proximate to a location on a surface corresponding to the location of the detected subject in the predetermined area. There is also a control unit that is electrically coupled to the detector and the projector. The control unit functions to, obtain a representation of the subject, determine a subject area of a surface corresponding to the representation of the subject, and provide the at least one communication to the projector. The representation of the subject is obtained, for example, from data of an image, e.g., thermal or optical, as captured by the detector.

The disclosed subject matter is also directed to a computer-usable storage medium. This storage medium has a computer program embodied thereon for causing a suitably programmed system to provide at least one communication to at least one subject, by performing the following steps when such program is executed on the system. The steps include: obtaining a representation of a subject; determining an area on a surface corresponding to the representation of the subject; providing at least one communication to the projector for the subject; and causing the projector to provide at least one communication at least proximate to the area on the surface.

The disclosed subject matter is also directed to a method for delivering at least one communication to at least one subject in a predetermined area based on the subject's direction of travel in the predetermined area. The method includes detecting a subject at a first time and assigning a first position where the subject was detected at the first time and detecting the subject at a second time, subsequent to the first time, making a representation of the subject at the second time, and assigning a second position where the subject was detected at the second time. A subject area for a surface corresponding to the representation of the subject is then determined. The direction of travel of the subject is then determined based on the first position and the second position and the location of the second position within the predetermined area. At least one communication is provided at least proximate to the subject area on the surface based on the direction of travel of the subject within the predetermined area. The predetermined area is, for example, a work area in which the detector and projector have an operative range.

The disclosed subject matter is also directed to a system for providing at least one communication to a subject in accordance with the direction of travel of the subject, for example, in a predetermined area. The system includes a detector for detecting a subject in a predetermined area and a projector for projecting at least one communication at least proximate to the location on a surface corresponding to the position of the detected subject in the predetermined area. There is a control unit that is electrically coupled to the detector and the projector. The control unit is such that it performs the functions of: assigning a first position to a subject detected at a first time; assigning a second position to the subject detected at a second time, subsequent to the first time, and obtaining a representation of the subject at the second time; determining a subject area for a surface corresponding to the representation of the subject at the second time; determining the direction of travel of the subject based on the first position and the second position, and the location of the second position within the predetermined area; and, causing at least one communication to be provided at least proximate to the subject area on the surface based on the direction of travel of the subject within the predetermined area.

The disclosed subject matter is also directed to a computer-usable storage medium. This storage medium has a computer program embodied thereon for causing a suitably programmed system to provide at least one communication to at least one subject based on the subject's direction of travel, by performing the following steps when such program is executed on the system. The steps include: assigning a first position where a subject was detected at the first time; assigning a second position where a subject was detected at a second time, subsequent to the first time; obtaining a representation of the subject at the second time from data corresponding to the detected subject; determining a subject area for a surface corresponding to the representation of the subject; determining the direction of travel of the subject based on the first position and the second position and the location of the second position within the predetermined area; and, providing at least one communication to be delivered at least proximate to the subject area on the surface based on the direction of travel of the subject.

### BRIEF DESCRIPTION OF THE DRAWINGS

Attention is now directed to the drawing figures, where like or corresponding numerals or characters indicate corresponding or like components. In the drawings:

FIG. 1A is a diagram of a portion of an exemplary system supporting the disclosed subject matter;

FIG. 1B is a block diagram of the control system of the exemplary system of FIG. 1A;

FIGS. 2A and 2B are flow diagrams detailing exemplary processes performed in accordance with the disclosed subject matter;

FIG. 3 is a screen diagram associated with the process of FIGS. 2A and 2B;

FIGS. 4A-4D are overhead schematic diagrams of the system of the disclosed subject matter in an exemplary operation;

FIG. 5A is a diagram detailing an exemplary operation of the disclosed subject matter;

FIG. 5B is an overhead schematic diagram of the system in the exemplary operation of FIG. 5A;

FIGS. 6A and 6B are diagrams of an alternate system of the disclosed subject matter in an exemplary operation;

FIGS. 7A and 7B are flow diagrams detailing another exemplary process performed in accordance with the disclosed subject matter; and

FIG. 8 is an overhead schematic diagram of the system in the exemplary operation of FIGS. 7A and 7B.

### DETAILED DESCRIPTION

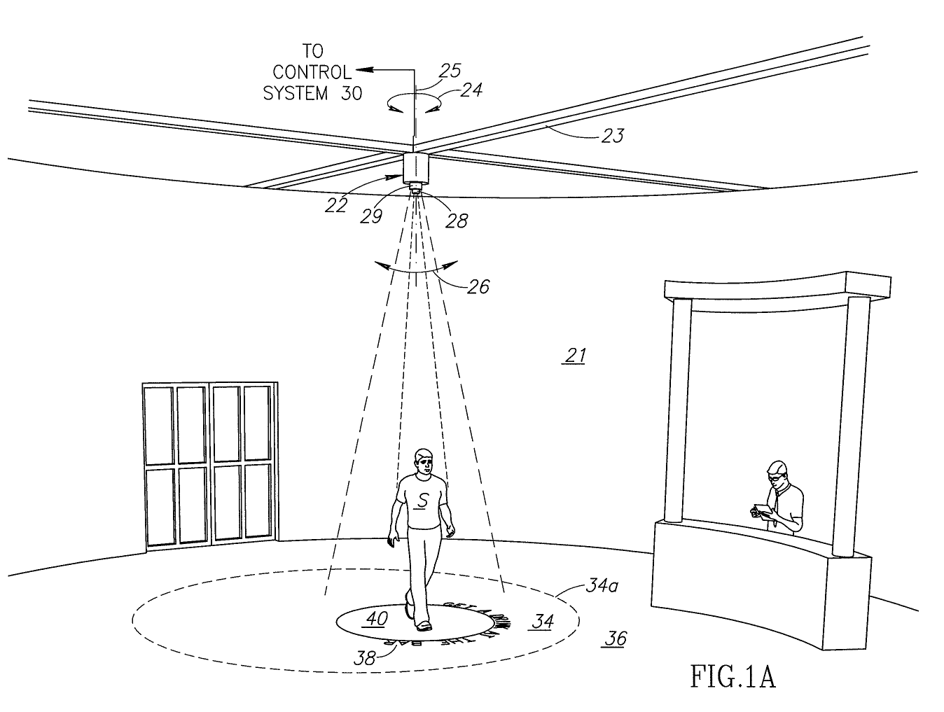

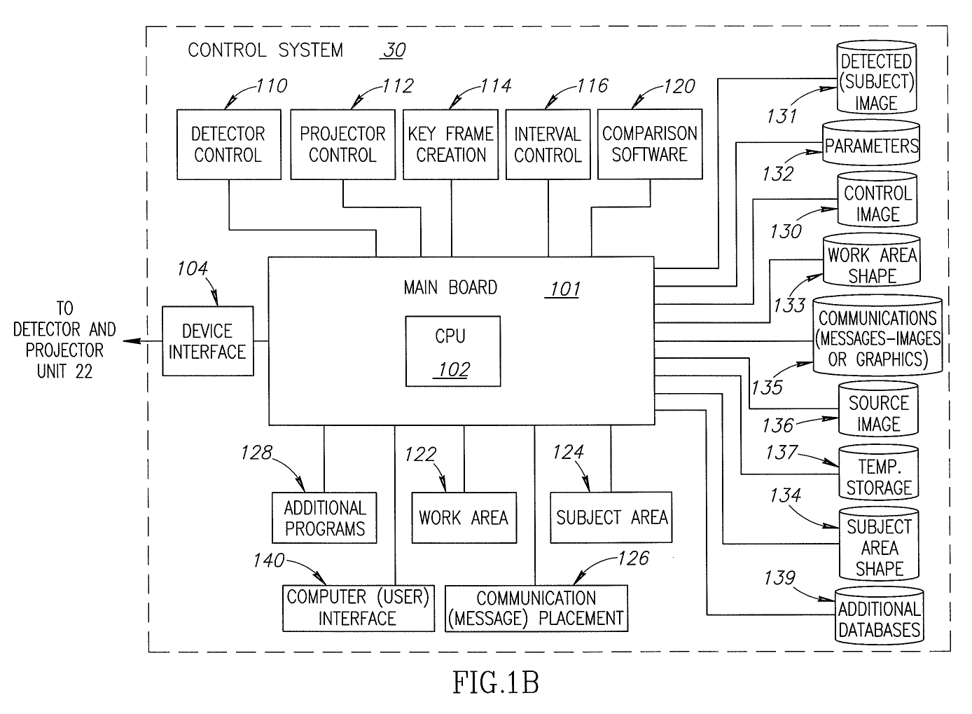

FIG. 1A details a system 20 of the present disclosed subject matter, operating, for example, in a room 21, atrium, foyer or other space. The system 20 includes a detector and projector unit 22, mounted, for example, to a static structure, such as a ceiling 23, frame or the like, to cover a complete, 360° range of rotational motion (indicated by the double headed arrow 24 about the axis 25), as well as approximately 180° or angular motion (indicated by the double headed arrow 26 about the axis 25).

The detector 28 of the detector and projector unit 22 may be a thermal camera or detector, that utilizes thermal imaging, to detect a subject and create a thermal image thereof, or an optical camera or detector, that utilizes light and light-based imaging to detect a subject, and make an optical image thereof or a combination of optical and thermal inputs. The projector 29 of the detector and projector unit 22 may be, for example, a light projector. This detector and projector unit 22 is electronically linked, by wired or wireless links, or combinations thereof, to a control system 30.

The detector and projector unit 22 functions within a work area 34, that is, for example, shown bounded by the broken lines 34a, for emphasis only. The work area 34 is established by the control system 30 on a surface 36, for example, the floor, or the like. The detector and projector unit 22, as programmed through the control system 30, recognizes the subject S (also known as the recipient) once the subject has entered the work area 34, or is within the work area at a location programmed for detection to begin. Once the subject is detected and confirmed to be a suitable subject for transmission of a communication, for example, a message, a visible message 38 is projected to the subject S within the work area 34 proximate to an subject area 40 established for the subject S.

The detector and projector unit 22 continues to project messages 38 to the subject S until the subject S leaves (is outside) of the work area 34, or there is a controlled termination by the control system 30. During this process, the detector and projector unit 22 continues to input and record location data from S, for example, in the form of coordinates corresponding to the subject (S) location. The control system 30 also maintains the subject area 40 and may continue with the same message 38, project different messages, for example, changed at random or regularly spaced time intervals, or project messages based on the location of the subject S in the work area 34, or the direction of the subject S. The detector and projector unit 22, tracks the subject S and project messages accordingly. The aforementioned functioning of the system 20 is detailed further below.

Turning also to FIG. 1B, the control system 30 is shown in detail. The control system 30 includes a main board 101 with a central processing unit (CPU) 102 and all electronics necessary for proper operation of the control system 30. The CPU 102, for example, includes one or more processors, microprocessors, or the like.

A device interface 104, for interfacing with the detector and projector unit 22, is electronically linked, by wired or wireless links, or combinations thereof, to the detector and projector unit 22 and the main board 101 and accordingly, the CPU 102. Hereinafter, “electronically linked” includes wired or wireless links, or combinations thereof.

There are also, for example, algorithms and the like, for controlling the detector 110, the projector 112, key frame creation 114, and interval control 116, all electronically linked to the main board 101 (and accordingly, the CPU 102). There is also software or the like 120 for comparing the control image to the image obtained from the detector (also known as a subject image), electronically linked to the main board 101 (and accordingly, the CPU 102).

There are also, for example, algorithms and the like, for controlling the work area 122 and subject area 124 and communication placement, for example, message placement 126 (including orienting the communication, for example, a message, with respect to the detected subject), for placement of the message 38 with respect to the subject area 40, as shown for example in FIG. 1A. There are also additional algorithms and programs, represented by the box 128 for other functions associated with the control system 30.

The control system 30 also includes databases, caches and other storage media. Exemplary databases, caches or storage media include those for control images 130, detected or subject images 131, parameters for evaluating the detected or subject images 132, shapes for the work area 133, shapes for the subject area 134, the various communications, such as messages, for example, in the form of visual images (graphics) 135 for projection to the requisite subject (recipient) with respect to the subject area, or object associated with the subject (recipient), source images 136, and temporary storage 137. There are also additional databases, represented by the database 139.

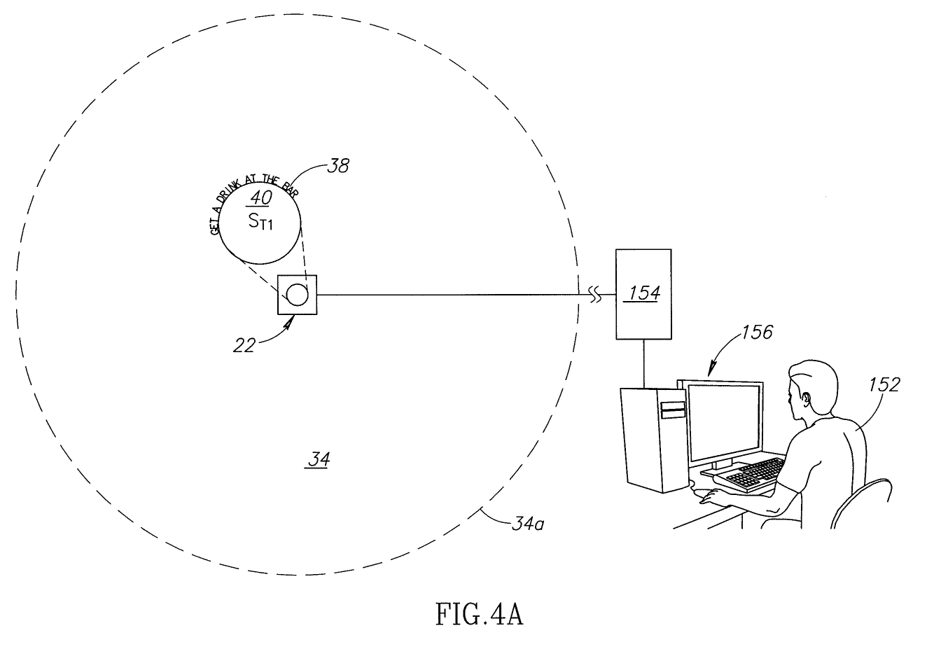

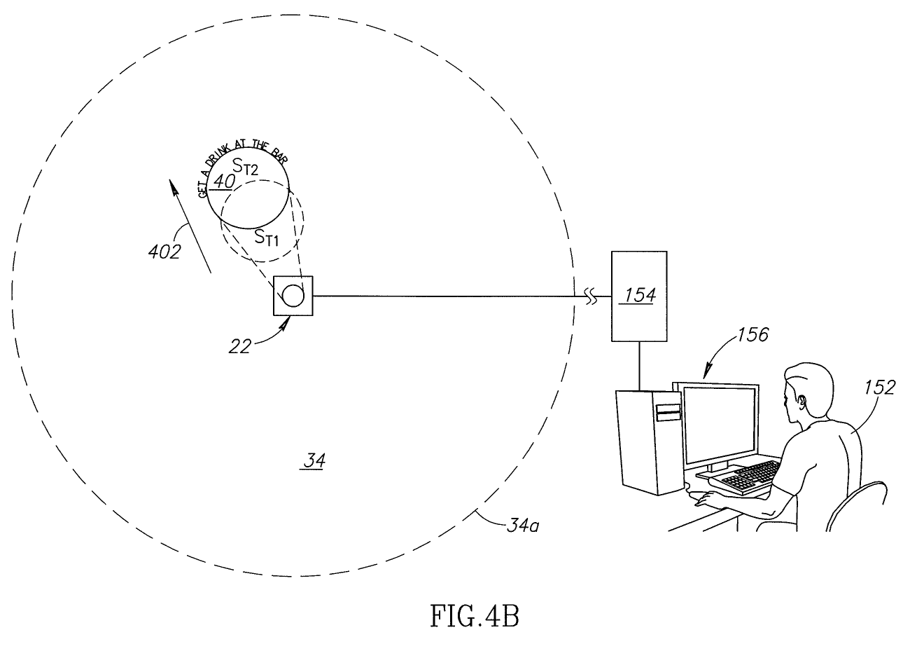

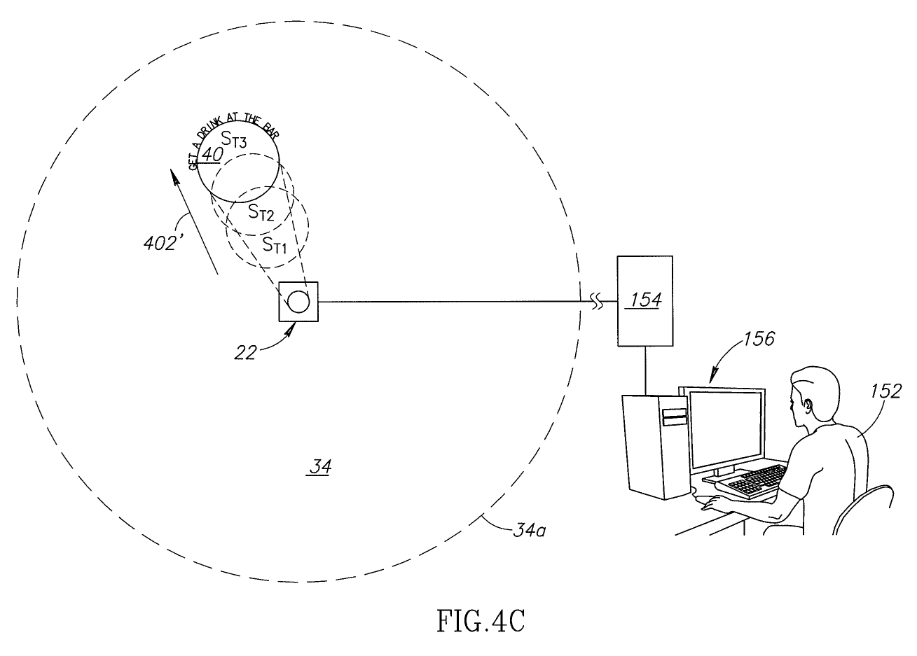

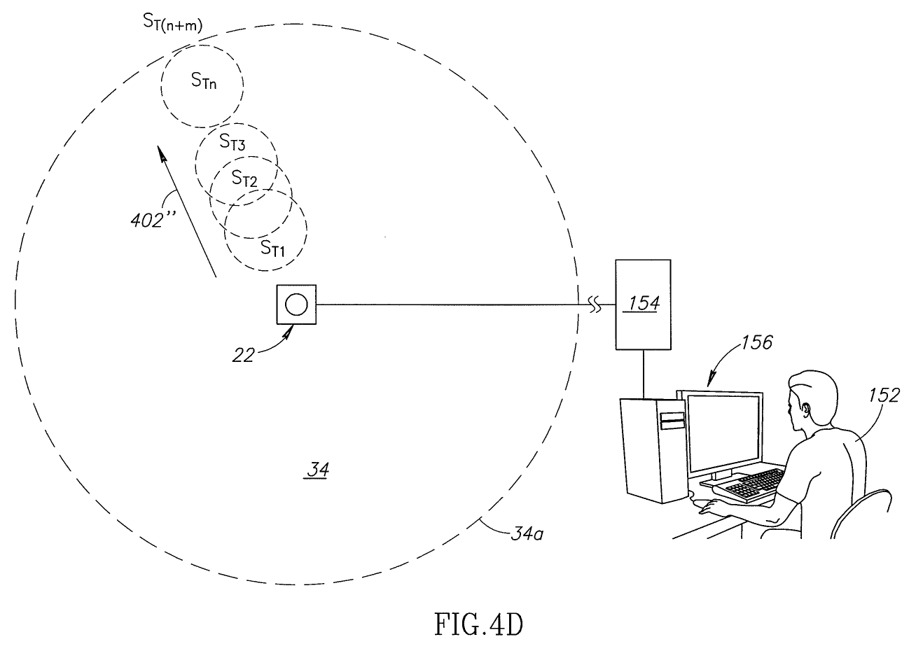

The main board 101 and CPU 102 are such that all components 104, 110, 112, 114, 116, 120, 122, 124, 126, 128, 130-137 and 139 are in electronic communication with each other. All of these aforementioned components are controllable and where suitable, programmable through the computer interface 140, that is, for example, electronically linked to the computer 150, of a system administrator 152 or other similar entity, as shown, for example, in FIGS. 4A-4D, 5B and 6A-6C. The control system 30 is located, for example, in one or more servers 154 (FIGS. 4A-4D, 5B and 6A-6C), computers, computer-type devices, work stations and the like.

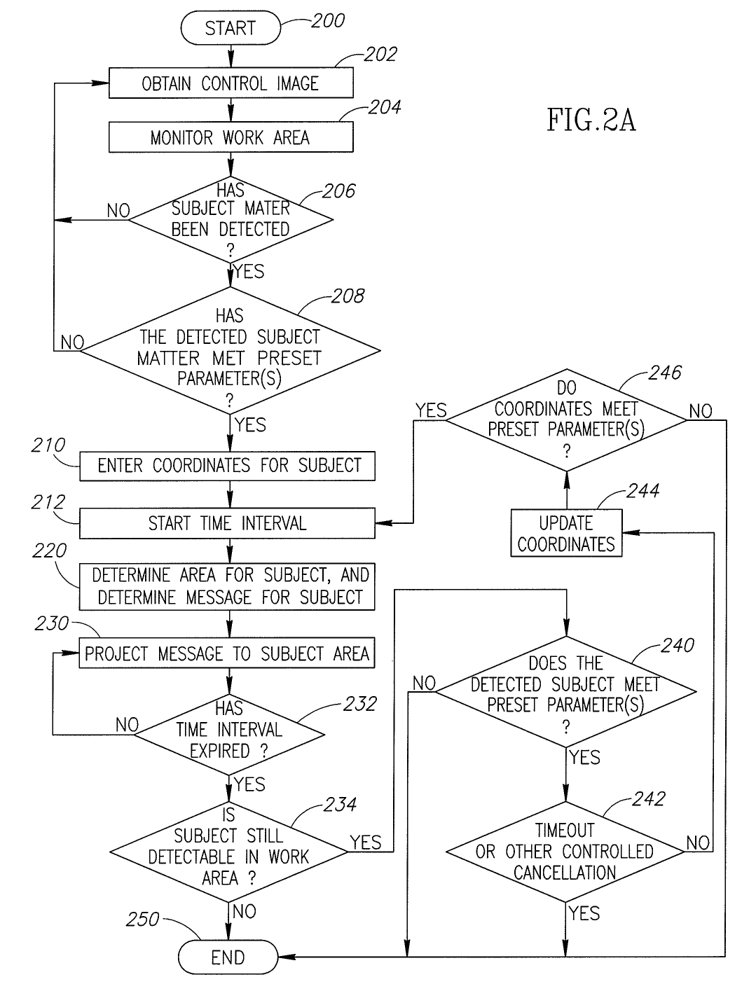

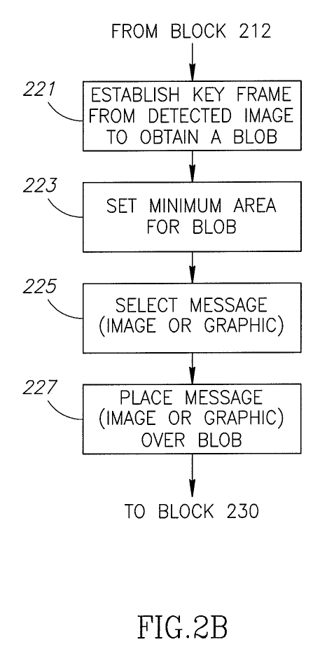

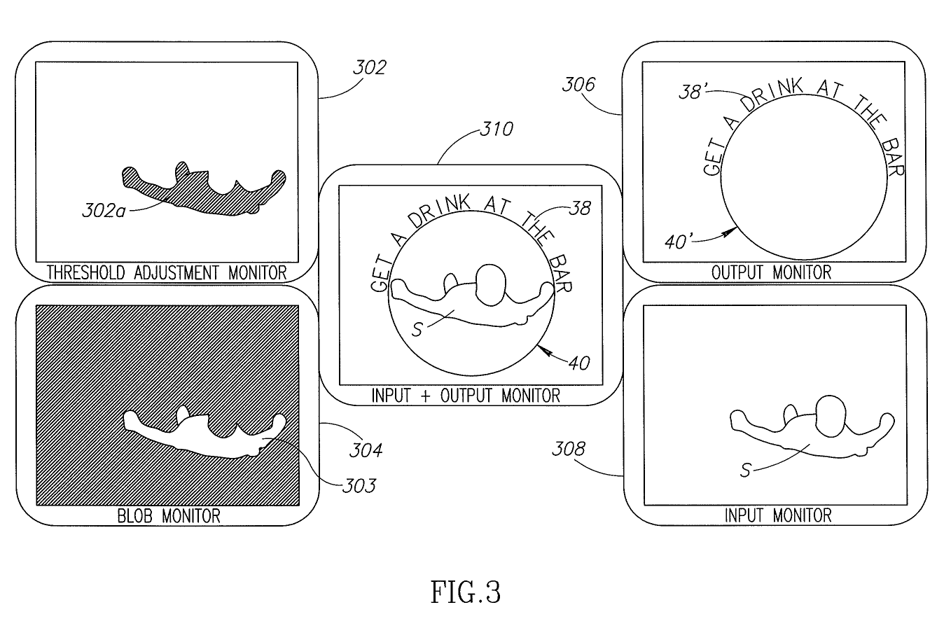

Attention is now directed to the flow diagrams of FIGS. 2A and 2B, that detail an exemplary processes in accordance with the disclosed subject matter. Attention is also directed to FIG. 3, to illustrate the below described processes of FIGS. 2A and 2B.

The process begins with the START, at block 200. Initially, an image of the surface of a portion of the work area 34 is taken, at block 202. This image becomes the control image, and is stored in the database for control images 130. The image may be, for example, a thermal image, an optical image, or a combination thereof, or the like, made by the detector 28.

The work area 34 is monitored, at block 204 for subject matter detectable by the detector 28 of the detector and projector unit 22. The detector 28 continuously scans and images the work area 34. For example, the scanning is at predetermined intervals, the intervals set by the interval control algorithm 116.

The process moves to block 206, where it is determined if subject matter has been detected. This is done by comparing the live or instant image to the control image. The live image is a thermal image, an optical image, or a combination thereof, so as to be the same kind of image as the control image. The live image may be stored in the Detected Images database 131 and compared with the control image or utilized directly in the comparison. The comparison software 120 is utilized in accordance with preprogrammed parameters from the database 132.

Should subject matter, for example, an individual (person), group of individuals, or object or group of objects associated therewith, enter into the work area 34, the detector 28 images the detected subject matter, to determine if a potential subject or object, collectively, “subject matter” has been detected in the work area. Remaining in block 206, the live image is compared to the control image by comparison software 120, in accordance with preprogrammed parameters, from the database 132.

If the live image does not meet the requisite parameter(s) for example, the size parameters for the image based on the area of pixilation (programmed into the database 132), the detected subject matter is not significant, whereby the process returns to block 202. If the live image meets the requisite parameter(s) (programmed into the database 132), the process moves to block 208.

At block 208, it is determined if the detected subject matter has met the requisite preset parameter(s). This is performed, for example, by comparing the main portion of the live or detected image to preset parameter(s), stored in the database 132. The main portion of the image is the portion of the live image different from the control image, that is, for example, stored in the database 131. If the requisite parameter(s) for the main portion from the live image have not been met, the process returns to block 204. If the requisite parameters have been met, the process moves to block 210.

For example, the determination at block 210 may be in accordance with a pixel count of the main portion of the live image. This way, a small ball rolling across the surface, although detected and imaged by the detector 28, the requisite image portion may not have a sufficient pixel count and will not be considered a subject or object for a message. However, a human being, as imaged, will be of a sufficient pixel count to be the subject for a projected message. The requisite pixel count is programmable into the database 132 and may be programmed to accommodate the minimum sizes for desired subjects. Programming may be, for example, through the interface 140.

By moving to block 210, the imaged subject matter of the live or detected image is now considered to be a proper subject or object, for which a message will be provided, at block 210.

At block 210, the coordinates in the work area 24 for the subject, who is suitable for a transmitted communication, e.g., message, are noted, and may be placed in the temporary storage 137, such as databases or caches. By noting and recording, and in some cases storing, these coordinates, the control system 30, through the detector 28 begins tracking the subject (S). The process moves to block 212.

At block 212, a time interval is started. The process moves to block 220, where the area 40 for the subject or object associated therewith (of the live or detected image) to whom a message will be projected, as well as the actual message is determined.

Attention is now directed to FIG. 2B, that shows the sub processes associated with the process of block 220. Attention is also directed to FIG. 3.

In FIG. 2B, the process moves to block 221, where a key frame is established. The key frame is from the thermal or optical image of the detected subject, as shown in subscreen 302. This key frame is created by capturing a source image (formerly the live or detected image), and extracting the image of the subject or object 302a out of the source image. The extracted image is converted into a representation, known as a blob 303. The blob 303 is shown on the subscreen 304. A minimum area, corresponding to the subject area 40, is then determined and set for the blob 303, at block 223.

A message 38′, for example, in the form of an image or graphic, is now selected for the blob and as well as the position of the message 38′ with respect to the minimum area 40′ for the blob 303, at block 225. The message 38′ and the arrangement of the message is shown on subscreen 306. The message may be selected based on numerous criteria, such as random or regular time intervals, location of the subject or object associated therewith in the work area 34, as detailed below.

The message is placed over the blob 303, at block 227. The blob 303 is converted back to an image of the subject S, as shown by the subscreen 308.

The process moves to block 230 and back to FIG. 2A, as the projector 29 transmits the message 38 onto the surface 36 proximate to the subject S, in the work area 34. The projected message 38 is such that it is visible to the average human, within the range of visible light, for example. An optical image of the message 38 as projected onto the surface 36 proximate to the subject S and the subject area 40, for example, at the periphery of the subject area 40, is shown in subscreen 310. This is also shown in FIG. 1A and represented diagrammatically in FIG. 4A.

The process moves to block 232, where it is determined if the time interval has expired. If the time interval has not expired, the process returns to block 230, where the message (graphic, image or the like) continues to be projected to the subject S, with respect to the subject area 40. The time interval may be, for example, anywhere from 10 to 50 times a second, and may be 30 times a second. The time interval corresponds to the time interval at which the images are taken by the detector 28.

If the time interval has expired, the process moves to block 234. The sub process performed in this block is similar to that of block 206. The detector 28 searches for the subject (the subject matter), by continuously scanning and imaging the work area 34, and images the subject in the work area 34. This image is a live image, as above, and is compared to the control image, from the database 130. The comparison is performed by the comparison software 120, in accordance with preprogrammed parameters.

If the live image does not meet the requisite parameter(s) (programmed into the database 132), or matches the control image, the detected subject matter is not significant, whereby the process moves to block 250, where it ends. If the live image meets the requisite parameter(s) (programmed into the database 132), the process moves to block 240.

At block 240, the sub process performed in this block is similar to the sub process performed in block 208. It is determined if the detected subject matter meets the requisite preset parameter(s). This is performed, for example, by comparing the main portion of the live or detected image to preset parameter(s), stored in the database 132, the comparison made by pixel counts, as detailed above. If the requisite parameter(s) are not met, the process moves to block 250, where it ends. Alternately, if the requisite parameter(s) are met, the process moves to block 242.

At block 242, it is determined if there is a timeout or other controlled cancellation by the system. If there is a timeout or controlled cancellation, the process moves to block 250 and ends. Absent any timeouts or controlled cancellations, the process moves to block 244, where the coordinates of the subject, as defined for block 210 above, are updated. The coordinates may also be stored in the temporary storage 137.

The process moves to block 246, where the previous coordinates and the updated coordinates are compared, for example, by the comparison software 120. If the coordinates meet the requisite predetermined parameters, for example, when compared they do not exceed a predetermined distance, as stored in the parameters database 132, the subject is considered to be the same subject, and is tracked. The process returns to block 212, from where it repeats. Otherwise, if the compared coordinates do not meet the predetermined parameters, the process moves to block 250 where it ends.

With the process having returned to block 212, a new time interval is started. The process continues from block 212 until the subject is no longer detectable in the work area 34 and is proper for a message, or there is a timeout or other controlled cancellation.

The above process is performed for example, where random messages, messages switched at various time intervals, or messages based on a subject's or object's location in the work area 24, are provided.

Attention is now directed to FIGS. 1A and 4A-4D that show the above detailed process diagrammatically. In FIG. 1A, the subject S, at time T1, the start of a first time interval, has been detected by the detector 28 of the detection and projection unit 22. A message has been projected to the Subject S at this time T1, in accordance with the process of FIGS. 2A and 2B, as detailed above.

FIG. 4A is an overhead diagram of FIG. 1A. Proximate to the subject area 40, the subject S has received a message 38, for example, “GET A DRINK AT THE BAR.”

The subject S continues to move in the work area 34, in the direction of the arrow 402. At a second time T2, corresponding to a second time interval, the subject S remains in the work area 36, and the process of FIGS. 2A and 2B from block 212 repeats, as the subject S was in the work area 34 after time T1, and suitable for a projected message, as per blocks 234 and 240 (and there were not any timeouts or other controlled cancellations, as per block 242). Accordingly, the subject S is tracked as the message 38 remains with the subject S, as shown in FIG. 4B, at time T2, corresponding to a second time interval. The former position of the subject S at the previous interval, corresponding to time T1, is shown in broken lines.

In FIG. 4C, the subject S continues to move in the work area 34, in the direction of the arrow 402′. At time T3, corresponding to a third time interval, the subject remains in the work area 36, and the process of FIGS. 2A and 2B from block 212 repeats. Accordingly, the message 38 remains with the subject S, as the detector 28 tracks the subject S. The former positions of the subject S at the previous intervals of times T1 and T2 are shown in broken lines.

In FIG. 4D, the subject S continues to move, in the direction of the arrow 402″, but has now moved out of the work area 34. The last time interval where the subject S received a message was at time Tn (n representative of a final time in a time period). Since the subject S has left the work area 34 at time T(n+m) a time subsequent to time Tn, the message is no longer projected to the subject S, and the subject S is no longer tracked by the detector 28. The former positions of the subject S at previous intervals of times T1, T2, T3 through Tn are shown in broken lines.

In FIGS. 4A-4D, while a single message “GET A DRINK AT THE BAR” is projected, other messages could be projected at random or regular time intervals.

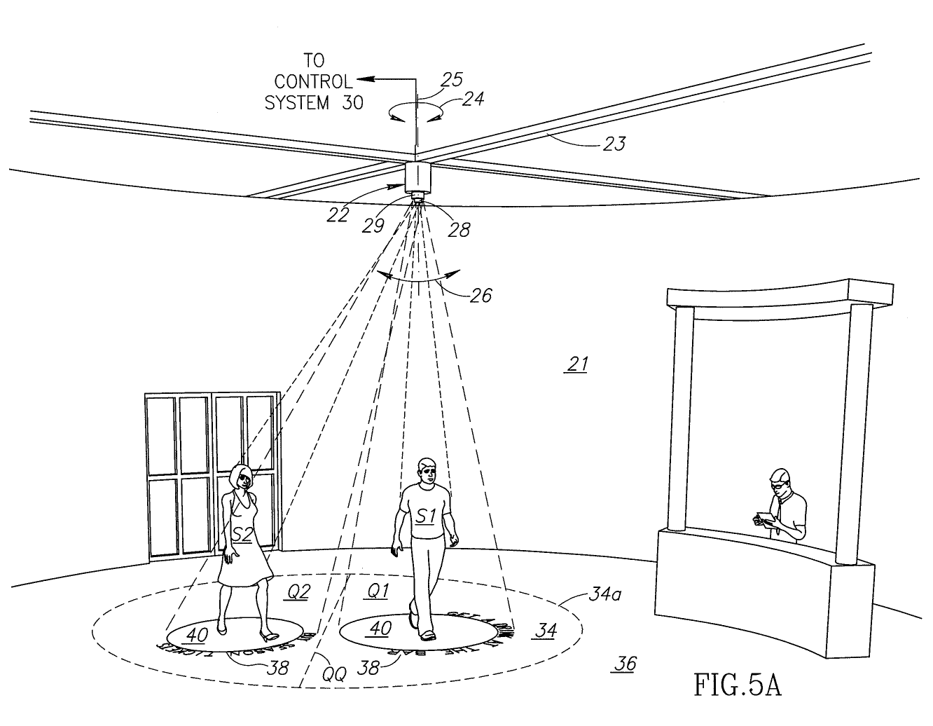

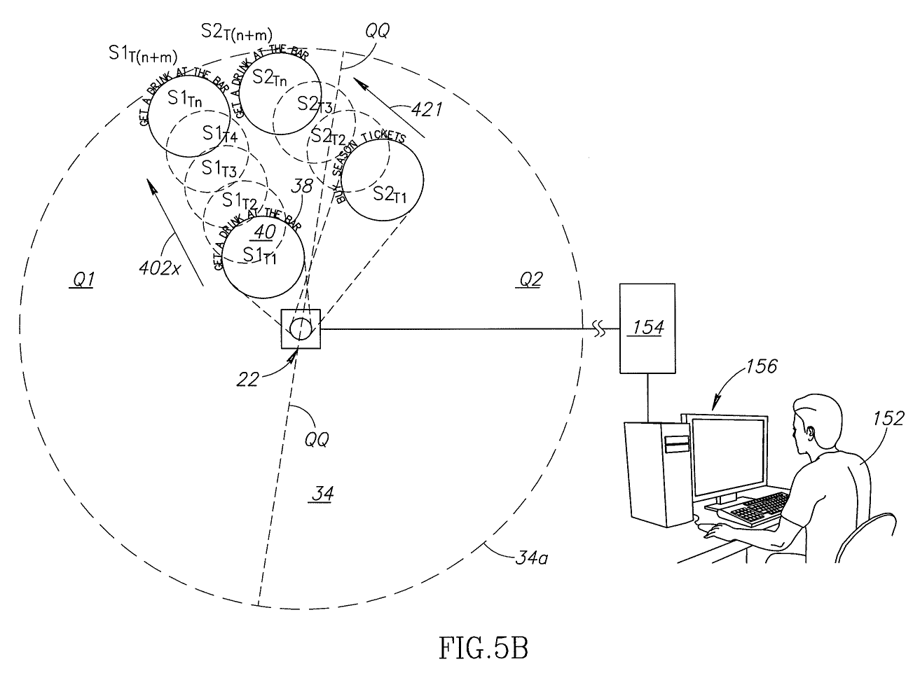

FIGS. 5A and 5B detail another form of projecting messages, based on the subject's location in the work area 34 (shown for emphasis by the broken lines 34a). In these figures, the work area 34 has been divided into two sections Q1 and Q2 (shown by the broken line QQ for emphasis only). There are two subjects, S1, corresponding to subject S in FIG. 1A, and S2.

The process operates as above. For example, the subject S1, walking in the direction of the arrow 402x, receives the same message, “GET A DRINK AT THE BAR.” This message remains with the subject S1, as he remains in the same section Q1, from the time (T1), when he is detected in the work area 34, and tracked by the detector 28 until the time (Tn), just before he leaves the work area 34.

As for subject S2, for example, she starts in section Q2 at time T1, where she is projected the message, “BUY SEASON TICKETS.” She walks in the direction of the arrow 421, where she is tracked by the detector 28. Once she crosses into section Q1, at time T3, she is projected the message “GET A DRINK AT THE BAR.” She continues to receives the message, “GET A DRINK AT THE BAR,” as she remains in the same section Q1, from the time T3, until the time (Tn), just before she leaves the work area 34.

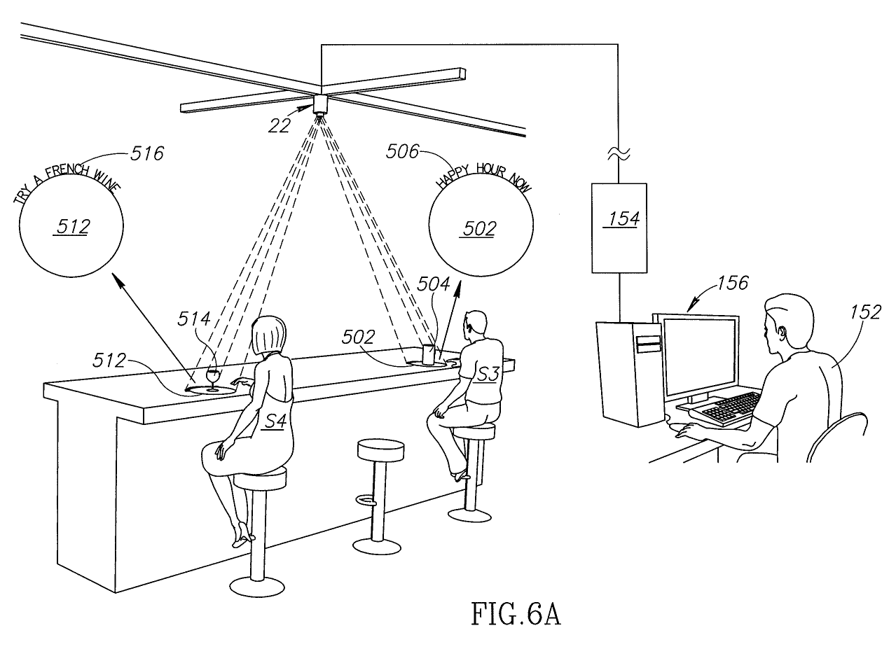

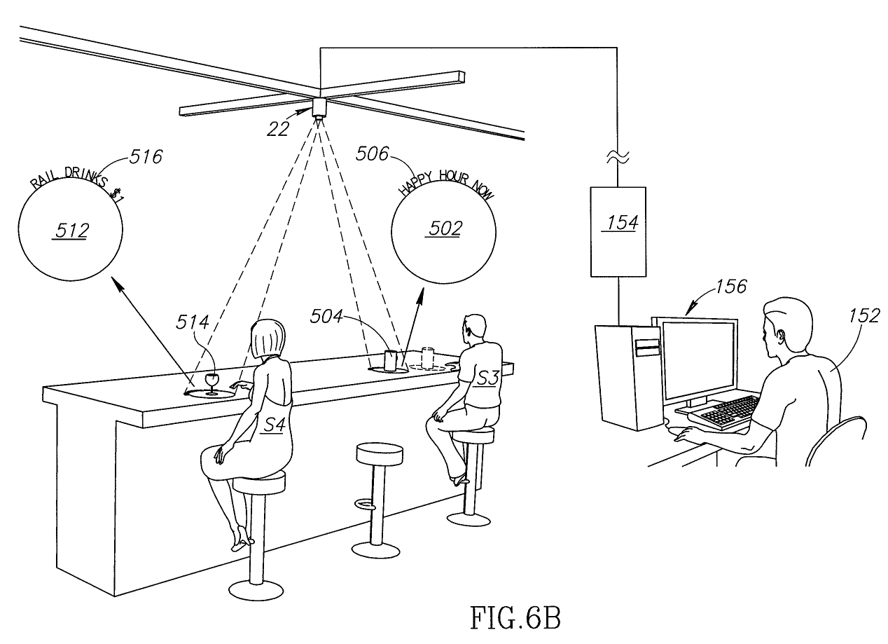

FIGS. 6A and 6B show the disclosed subject matter in exemplary operations on objects, associated with subjects S3 and S4. In FIG. 6A, at time T1, subject S3 receives a message 506, for example, “HAPPY HOUR NOW,” proximate to an area 502 corresponding to his object 504 (beer mug). Subject S4 receives a message 516, for example, “TRY A FRENCH WINE,” proximate to an area 512 corresponding to her object 514 (wine glass).

In FIG. 6B, at time Tx, subsequent to time T1, the object 504 for subject S3 has moved, while the object 514, for subject S4 has not moved. Although the object 504 moved (the former position shown in broken lines), the same message 506 is being projected to the object 504. Also, the object 514 has not moved, but it is receiving a different message 516, “RAIL DRINKS $1.” Alternately, a different message may be projected to object 504, and the same message may be projected to object 514.

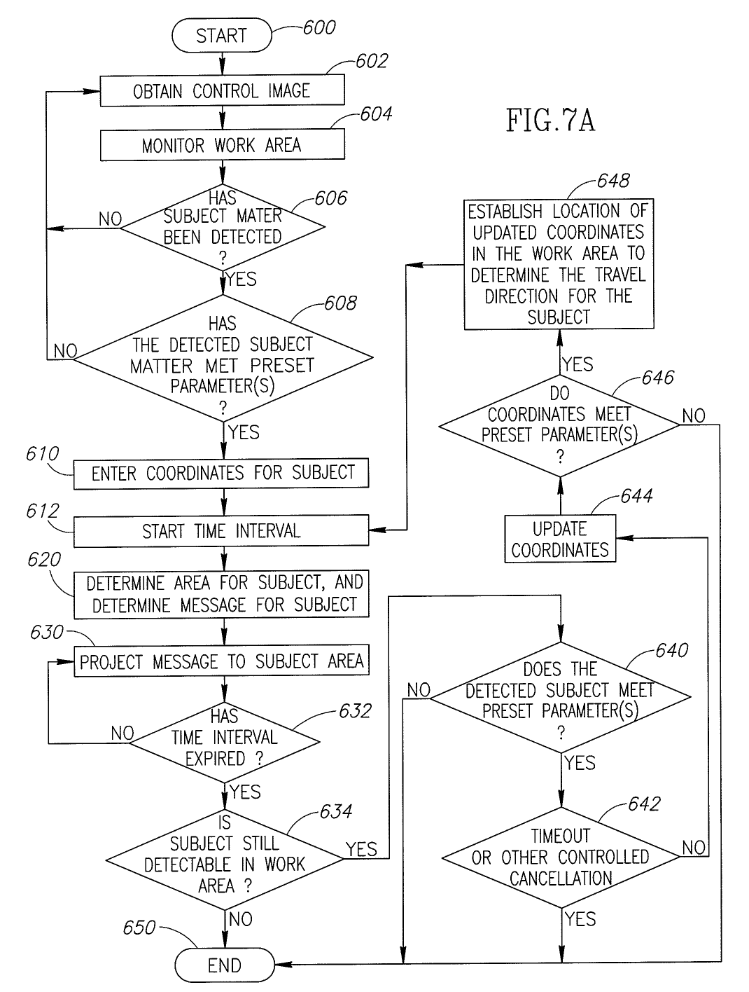

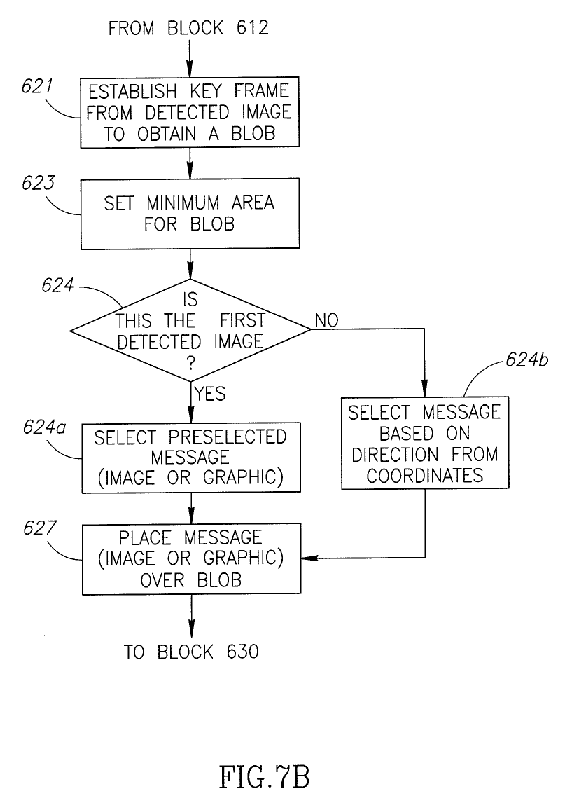

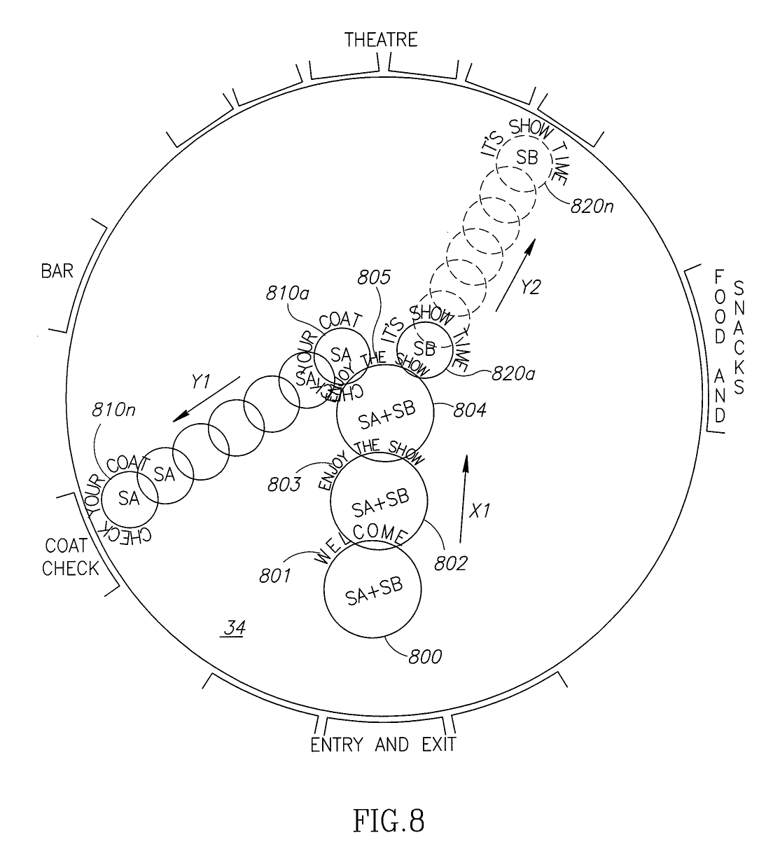

FIGS. 7A and 7B show another process for projecting messages based on the direction of travel of the subject in the work area 34. Attention is also directed to FIG. 8, to illustrate the below described processes of FIGS. 7A and 7B. In FIGS. 7A and 7B, similar sub processes are indicated by the same numbers as those in the “200” series of FIGS. 2A and 2B, and are numbered correspondingly in the “600” series. The descriptions of the corresponding numbered sub processes of the “600” series are in accordance with the descriptions for “200” series, with differences indicated below. Sub processes lacking a corresponding number in the “200” series are detailed below.

The process begins with the START, at block 600. Initially, an image of the surface of a portion of the work area 34 is taken, at block 602. This image becomes the control image, and is stored in the database for control images 130. The image may be, for example, a thermal image, an optical image, or a combination thereof, or the like, made by the detector 28, as detailed above.

The work area 34 is monitored at block 604 for subject matter detectable by the detector 28, of the detector and projector unit 22. The detector 28 continuously scans and images the work area 34. For example, the scanning is at predetermined intervals, the intervals set by the interval control algorithm 116.

The process moves to block 606, where it is determined if subject matter has been detected. This is done by comparing the live or instant image to the control image, as detailed above. Remaining in block 606, the live image is compared to the control image by comparison software 120, in accordance with preprogrammed parameters, from the database 132, as detailed above.

If the live image does not meet the requisite parameter(s), for example, the size parameters for the image based on the area of pixilation (programmed into the database 132), the detected subject matter is not significant, whereby the process returns to block 602. If the live image meets the requisite parameter(s) (programmed into the database 132), the process moves to block 608.

At block 608, it is determined if the detected subject matter has met the requisite preset parameter(s). If the requisite parameter(s) for the main portion from the live image have not been met, the process returns to block 604. If the requisite parameters have been met, the process moves to block 610.

By moving to block 610, the imaged subject matter of the live or detected image is now considered to be a proper subject or object, for which a message will be provided. At block 610, the coordinates in the work area 34 for the subject, who is suitable for a transmitted communication, e.g., message, are noted, and may be placed in the temporary storage 137, such as databases or caches. By noting and recording, and in some cases, storing these coordinates, the control system 30, through the detector 28, begins tracking the subject. Initially, for example, in FIG. 8, the subject represented by the two entities SA and SB combined, is tracked, and later, after the entities separate and travel in their respective separate directions, SA and SB are individually tracked, as detailed below. The process moves to block 612.

At block 612, a time interval is started. The process moves to block 620, where the area for the subject or object associated therewith (of the live or detected image) to whom a message will be projected, as well as the actual message is determined.

Attention is now directed to FIG. 7B, that shows the sub processes associated with the process of block 620. In FIG. 7B, the process moves to block 621, where a key frame, as defined above, is established. The key frame is used to form a blob of the entities defining the subject, as detailed above. A minimum area, corresponding to the subject area is then determined and set for the blob, at block 623. Initially, the blob is based on the entity formed by the subject (SA and SB combined) and once separated, the subjects (SA and SB) individually.

The process moves to block 624, where it is determined if this is the first detected image. If this is the first detected image, the process moves to block 624a, where a reselected, preprogrammed or assigned message is selected for the detected image. This sub process occurs at only the first interval, for example, the interval at time T1.

If this is not the first detected image, as is the case for all subsequently detected images, the process moves to block 624b, where a message is selected based on the detected coordinates, and the direction of travel of the subject, as discussed below with reference to a second or subsequent interval, of times T2-Tn.

With the sub processes of either of block 624a or 624b complete, the message is placed over the blob, at block 627, as detailed above. The blob is converted back to an image of the subject.

The process moves to block 630 and back to FIG. 7A, as the projector 29 transmits the message 38 onto the surface 36 proximate to the subject, for example, the subject defined by the combined entities SA and SB, with SA and SB being separate entities at subsequent times, in the work area 34, as detailed above. As this is the first detected image, for example, the entities SA and SB, based on their close proximity, were imaged as a single subject and have been projected a predetermined initial message “WELCOME” in circle 800, representative of the subject area at the interval for time T1, in FIG. 8.

The process moves to block 632, where it is determined if the time interval has expired. If the time interval has not expired, the process returns to block 630, where the message (graphic, image or the like) continues to be projected to the subject, with respect to the subject area. The time interval may be, for example, in accordance with the time intervals detailed above.

If the time interval has expired, the process moves to block 634. The sub process performed in this block is similar to that of block 606. As detailed above, the detector 28 searches for the subject (the subject matter), by continuously scanning and imaging the work area 34, and images the subject in the work area 34. This image is a live image, as above, and is compared to the control image, from the database 130. The comparison is performed by the comparison software 120, in accordance with preprogrammed parameters.

If the live image does not meet the requisite parameter(s) (programmed into the database 132), or matches the control image, the detected subject matter is not significant, whereby the process moves to block 650, where it ends. If the live image meets the requisite parameter(s) (programmed into the database 132), the process moves to block 640.

At block 640, the sub process performed in this block is similar to the sub process performed in block 608. It is determined if the detected subject matter meets the requisite preset parameter(s). This is performed, for example, by comparing the main portion of the live or detected image to preset parameter(s), stored in the database 132, the comparison made by pixel counts, as detailed above. If the requisite parameter(s) are not met, the process moves to block 650, where it ends. Alternately, if the requisite parameter(s) are met, the process moves to block 642.

At block 642, it is determined if there is a timeout or other controlled cancellation by the system. If there is a timeout or controlled cancellation, the process moves to block 650 and ends. Absent any timeouts or controlled cancellations, the process moves to block 644, where the coordinates of the subject, as defined for block 610 above, are updated. The coordinates may also be stored in the temporary storage 137.

The process moves to block 646, where the previous coordinates and the updated coordinates are compared, for example, by the comparison software 120. If the compared coordinates do not meet the predetermined parameters, the process moves to block 650, where it ends.

If the coordinates meet the requisite predetermined parameters, for example, when compared they do not exceed a predetermined distance, as stored in the parameters database 132, the subject is considered to be the same subject, and is tracked. The process now moves to block 648 where the analyzed coordinates, corresponding to the subject's movement to his present position from his previous position (the change in position), coupled with the coordinates corresponding to the present position of the subject in the work area 34, to establish a direction of travel with respect to the work area 34. It is the direction of travel, that is used to determine an individualized direction and location specific message (communication) that is selected for and projected to the particular subject. The process moves to block 612, where a new interval is started, and a message will be selected for the subject, depending on the continued direction of travel of the subject, provided the subject remains in the work area 34.

From block 612, the process continues, as detailed above, for blocks 612-650, except when in block 620, a second or other subsequent image has been detected previously (from blocks 634-648), and the process selects the message through blocks 624 and 624b. In block 624b, the message is selected based on the direction the subject is moving (for example, the direction of travel), as determined from the analysis of the coordinates (corresponding to the previous and present positions of the subject) and the present position of the subject in the work area 34. Once the message is selected, from the various messages in the storage media 135, the process moves to block 627, where it continues as detailed above.

For example, with the subject formed of SA and SB, the subject area, represented by the circle 802 (FIG. 8) includes updated coordinates, such that the direction of the subject is now determined at the interval represented by the time T2. As the subject remains in and continues to move in the work area 34, the process again moves through blocks 634-648, and returns to block 612, from where it repeats, as detailed above.

Turning specifically to FIG. 8, initially, a subject is formed from the combination of SA and SB. This combination of SA and SB forms the blob, over which a reselected, preprogrammed or assigned message “WELCOME” 801 is projected to the subject area 800, corresponding to the first image of the first interval, at time T1. In the flow diagram of FIGS. 7A and 7B, the process moves from block 600 to block 632, through block 624a.

The subject, formed by SA and SB, continues to move in the work area in the direction of the arrow X1, and accordingly, the process moves from block 634 to block 648. During these sub processes, the coordinates are evaluated for the distance between them and the location in the work area, in order to indicate a direction of travel for the subject. The process then moves to block 612, where a new, subsequent or second interval at time T2 begins.

The process moves through blocks 620 to 632 and a message 803, for example, “ENJOY THE SHOW,” is provided to the subject area 802, through the sub process of block 624b. This second message, “ENJOY THE SHOW” is based on the direction of movement of the subject, SA and SB combined, in the work area 34.

The process moves from block 634 to block 612, for the subject (SA and SB combined), and a new or third interval, at time T3 is started. The message for the interval at time T3 is provided in the same manner as was the message for the previous interval at time T2 (the process moving from blocks 620-632, through block 624b), from an analysis of the coordinates for distance there between and direction of travel, with respect to the work area 34. Similarly, the subject area represented by the circle 804 receives the same message 805 “ENJOY THE SHOW,” as the subject SA and SB continue in the same direction of travel (represented by arrow X1) in the work area 34.

Resuming from block 634 and moving to block 612 for a new interval, for example, the interval represented by time T4, the subjects SA and SB have separated, each moving in the work area 34 in separate directions, SA in the direction of the arrow Y1 and SB in the direction of arrow Y2. Circles 810a and 820a represent the subject areas of the separate subjects SA and SB at this interval at time T4. The subjects SA and SB are now imaged individually and blobs based on the individual subjects SA and SB are created, as the process moves from block 620 to block 648. For both subjects, SA and SB, messages are selected at blocks 624b based on the direction of travel (for example, indicated by the arrows Y1 and Y2, respectively). Accordingly, subject SA, heading toward the coat check, receives a message “CHECK YOUR COAT,” proximate to the subject area 810a, while subject SB, heading toward the theatre, receives the message “IT'S SHOWTIME,” proximate to the subject area 820a.

The process continues in this manner for subjects SA and SB, as detailed above, with movement of each subject. The process repeats from block 612 to block 648, and back to block 612 for each new interval, until the subjects have reached subject areas, represented by circles 810n and 820n, immediately prior to leaving the work area 34, at an interval, for example, represented as time Tn. Immediately after this time interval (Tn), one of the sub processes of blocks 634, 640, 642, or 646 will result in the process moving to block 650 where the process ends. For example, once out of the work area 34, subjects SA and SB are no longer subjects for imaging, such that the process ends.

The above-described processes including portions thereof can be performed by software, hardware and combinations thereof. These processes and portions thereof can be performed by computers, computer-type devices, workstations, processors, micro-processors, other electronic searching tools and memory and other storage-type devices associated therewith. The processes and portions thereof can also be embodied in programmable storage devices, for example, compact discs (CDs) or other discs including magnetic, optical, etc., readable by a machine or the like, or other computer usable storage media, including magnetic, optical, or semiconductor storage, or other source of electronic signals.

The processes (methods) and systems, including components thereof, herein have been described with exemplary reference to specific hardware and software. The processes (methods) have been described as exemplary, whereby specific steps and their order can be omitted and/or changed by persons of ordinary skill in the art to reduce these embodiments to practice without undue experimentation. The processes (methods) and systems have been described in a manner sufficient to enable persons of ordinary skill in the art to readily adapt other hardware and software as may be needed to reduce any of the embodiments to practice without undue experimentation and using conventional techniques.

While preferred embodiments of the disclosed subject matter have been described, so as to enable one of skill in the art to practice the present disclosed subject matter, the preceding description is intended to be exemplary only. It should not be used to limit the scope of the disclosed subject matter, which should be determined by reference to the following claims.

What is claimed is:

1. A method for delivering at least one communication to at least one recipient comprising:
detecting the subject corresponding to the recipient and making a representation of the subject at a first time;
determining a subject area on a surface corresponding to the representation of the subject; and,
providing at least one communication at least proximate to the subject area on the surface.

2. The method of claim 1, additionally comprising:
detecting the subject corresponding to the recipient and making a representation of the subject at least at one time subsequent to the first time;
determining a subject area on a surface corresponding to the representation of the subject; and,
providing at least one communication at least proximate to the subject area on the surface.

3. The method of claim 2, wherein the at least one time subsequent to the first time includes a plurality of times at predetermined intervals for continuously detecting the subject corresponding to the recipient and making a representation of the subject at each of the predetermined intervals.

4. The method of claim 3, wherein the providing the at least one communication includes providing the at least one communication at the periphery of the subject area on the surface.

5. The method of claim 2, wherein detecting the subject includes making an optical image of the subject.

6. The method of claim 2, wherein detecting the subject includes making a thermal image of the subject.

7. The method of claim 1, wherein the subject and the recipient are same.

8. The method of claim 1, wherein the subject and recipient are different.

9. A method for delivering at least one communication to a subject comprising:
continuously scanning a predetermined area at predetermined intervals to detect a subject;
making a representation of the subject at each predetermined interval while the subject remains detected;
determining a subject area on a surface corresponding to the representation of the subject; and,
providing at least one communication at least proximate to the subject area on the surface.

10. The method of claim 9, additionally comprising: continuously scanning the predetermined area until the subject is no longer detectable in the predetermined area.

11. The method of claim 9, wherein detecting a subject includes making at least one image of the subject.

12. The method of claim 11, wherein the at least one image is selected from the group consisting of optical images and thermal images.

13. The method of claim 11, wherein making a representation of the subject is based on the at least one image of the subject.

14. The method of claim 9, wherein the providing the at least one communication includes providing the at least one communication at the periphery of the subject area on the surface.

15. The method of claim 9, wherein the subject is selected from a group consisting of living beings, groups of living beings, objects, groups of objects, and groups of objects and living beings.

16. A system for providing at least one communication to a subject comprising:
a detector for detecting a subject in a predetermined area;
a projector for projecting at least one communication at least proximate to a location on a surface corresponding to the position of the detected subject in the predetermined area; and
a control unit in electronic communication with the detector and the projector, the control unit configured for:
obtaining a representation of the subject;
determining a subject area of a surface corresponding to the representation of the subject; and
providing the at least one communication to the projector.

17. The system of claim 16, wherein the detector includes an imaging device for producing data corresponding to an image of the subject.

18. The system of claim 17, wherein the imaging device is selected from the group consisting of a thermal camera and an optical camera.

19. The system of claim 17, wherein the control unit is additionally configured for:
causing the detector to continuously scan the predetermined area for the subject at time intervals of lengths of the predetermined time interval, after the subject has been detected in the detected in the predetermined area, and
during each predetermined time interval while the subject is detected in the predetermined area;
obtaining a representation of the subject;
determine a subject area of a surface corresponding to the representation of the subject;
provide at least one communication to the projector; and
cause the projector to provide the at least one communication at least proximate to the subject area on the surface.

20. The system of claim 19, wherein the control unit obtains a representation of the subject by making a representation of the subject from data corresponding to the image of the subject received from the detector.

21. The system of claim 20, wherein the control unit is additionally configured for detecting a subject from the group consisting of, living beings, groups of living beings, objects, groups of objects, and groups of objects and living beings.

22. A computer-usable storage medium having a computer program embodied thereon for causing a suitably programmed system to provide at least one communication to at least one subject, by performing the following steps when such program is executed on the system:
obtaining a representation of a subject;
determining an area on a surface corresponding to the representation of the subject;
providing at least one communication to the projector for the subject; and
causing the projector to provide at least one communication at least proximate to the area on the surface.

23. The computer-usable storage medium of claim 22, additionally performing the following steps:
determining if the detector has detected a subject.

24. The computer-usable storage medium of claim 22, wherein obtaining the representation of the subject includes obtaining data from a detector, the data corresponding to at least one image of the subject as provided by the detector upon detecting the subject.

25. The computer-usable storage medium of claim 24, wherein obtaining the representation of the subject is performed continuously at predetermined time intervals after the subject has been detected by the detector, and until the subject leaves the predetermined area.

26. The computer-usable storage medium of claim 25, additionally performing the following step:
causing the detector to continuously scan the predetermined area for the subject at time intervals of lengths of the predetermined time interval, after the subject has been detected in predetermined area.

27. The computer-usable storage medium of claim 26, additionally performing the following step:
for each obtained representation, determining a subject area for a surface corresponding to the representation of the subject;
providing at least one communication to the projector; and
causing the projector to provide the at least one communication at least proximate to the subject area on the surface.

28. The computer-usable storage medium of claim 27, additionally performing the following step:
detecting the subject from the group consisting of, living beings, groups of living beings, objects, groups of objects, and groups of objects and living beings.

29. A method for delivering at least one communication to at least one subject in a predetermined area comprising:
detecting a subject at a first time and assigning a first position where the subject was detected at the first time;
detecting the subject at a second time, subsequent to the first time, making a representation of the subject at the second time, and assigning a second position where the subject was detected at the second time;
determining a subject area for a surface corresponding to the representation of the subject;
determining the direction of travel of the subject based on the first position and the second position and the location of the second position within the predetermined area; and,
providing at least one communication at least proximate to the subject area on the surface based on the direction of travel of the subject within the predetermined area.

30. The method of claim 29, additionally comprising:
detecting the subject at an nth time, subsequent to the second time, making a representation of the subject at the nth time, and assigning an nth position where the subject was detected at the nth time;
determining a subject area for a surface corresponding to the representation of the subject;
determining the direction of travel of the subject based on the position of the subject at a time previous to the nth time, and the position of the subject at the nth time, and the location of the position at the nth time within the predetermined area; and,
providing at least one communication at least proximate to the subject area on the surface based on the direction of travel within the predetermined area.

31. The method of claim 30, wherein detecting the subject at the first time and detecting the subject at the second time and detecting the subject at the nth time includes obtaining at least one image of the subject.

32. The method of claim 31, wherein the at least one image is selected from the group consisting of optical images and thermal images.

33. The method of claim 30, wherein the providing the at least one communication includes providing the at least one visual communication at the periphery of the subject area on the surface.

34. The method of claim 31, wherein the subject is selected from a group consisting of living beings, groups of living beings, objects, groups of objects, and groups of objects and living beings.

35. A system for providing at least one communication to a subject comprising:
a detector for detecting a subject in a predetermined area;
a projector for projecting at least one communication at least proximate to the location on a surface corresponding to the position of the detected subject in the predetermined area; and
a control unit in electronic communication with the detector and the projector, the control unit configured for:
assigning a first position to a subject detected at a first time;
assigning a second position to the subject detected at a second time, subsequent to the first time, and obtaining a representation of the subject at the second time;
determining a subject area for a surface corresponding to the representation of the subject at the second time;
determining the direction of travel of the subject based on the first position and the second position, and the location of the second position within the predetermined area; and,
causing at least one communication to be provided at least proximate to the subject area on the surface based on the direction of travel of the subject within the predetermined area.

36. The system of claim 35, wherein the detector produces data corresponding to an image of the subject.

37. The system of claim 36, wherein the control unit configured for obtaining a representation of the subject at the second time includes creating a representation of the subject at the second time from the data corresponding to the image of the subject at the second time.

38. The system of claim 36, wherein the detector includes an imaging device, selected from the group consisting of a thermal camera and an optical camera.

39. The system of claim 35, wherein the control unit is additionally configured for:
determining if the subject detected by the detector is suitable to receive a communication.

40. The system of claim 35, wherein the control unit is additionally configured for:
controlling projection of the communication from the projector for a predetermined time interval at the second time.

41. The system of claim 35, wherein the control unit is additionally configured for detecting a subject from the group consisting of, living beings, groups of living beings, objects, groups of objects, and groups of objects and living beings.

42. A computer-usable storage medium having a computer program embodied thereon for causing a suitably programmed system to provide at least one communication to at least one subject, by performing the following steps when such program is executed on the system:
assigning a first position where a subject was detected at the first time;
assigning a second position where a subject was detected at a second time, subsequent to the first time;
obtaining a representation of the subject at the second time from data corresponding to the detected subject;
determining a subject area for a surface corresponding to the representation of the subject;
determining the direction of travel of the subject based on the first position and the second position and the location of the second position within the predetermined area; and,
providing at least one communication to be delivered at least proximate to the subject area on the surface based on the direction of travel of the subject.

43. The computer-usable storage medium of claim 42, wherein the data corresponding to the detected subject includes data of at least one image captured by a detector.

44. The computer-usable storage medium of claim 43, wherein the at least one image captured by a detector is selected from the group consisting of optical images and thermal images.

45. The computer-usable storage medium of claim 44, wherein the at least one communication to be delivered is a visual image.

46. The computer usable storage medium of claim 42, additionally performing the following steps:
determining if a subject has been detected prior to assigning the first position or the second position.

47. The computer usable storage medium of claim 42, additionally performing the following step:
detecting the subject from the group consisting of, living beings, groups of living beings, objects, groups of objects, and groups of objects and living beings.
